(19) United States
(12) Patent Application Publication
(10) Pub. No.: US 2016/0237367 A1
(43) Pub. Date: Aug. 18, 2016

(54) LUBRICANT COMPOSITION AND A METHOD TO LUBRICATE A MECHANICAL DEVICE

(71) Applicant: DOW BRASIL SUDESTE INDUSTRIAL LTDA, Santo Amaro (BR)

(72) Inventors: Yuri Alencar Marques, Freeport, TX (US); Abel de Oliveira, Sao Paulo (BR)

(73) Assignee: Dow Brasil Sudeste Industrial Ltda., Sao Paulo/Sp (BR)

(21) Appl. No.: 15/029,314

(22) PCT Filed: Oct. 24, 2014
(86) PCT No.: PCT/IB2014/002216

§ 371 Date: Apr. 14, 2016

Related U.S. Application Data
(60) Provisional application No. 61/896,673, filed on Oct. 29, 2013.

(51) Int. Cl. C10M 107/34; C08G 65/12

(52) U.S. Cl. CPC C10M 107/34; C08G 65/12; C10M 2209/105; C10N 2220/022; C10N 2220/026; C10N 2220/142; C10N 2230/02

(57) ABSTRACT

A lubricant composition comprising a polyoxypropylene polymer, the polyoxypropylene polymer having been prepared by polymerizing propylene oxide with an initiator containing a labile hydrogen in the presence of a double metal cyanide (DMC) catalyst, the polyoxypropylene polymer having a number average molecular weight ranging from 5,000 g/mol to 20,000 g/mol, a kinematic viscosity at 40° C. ranging from 1,200 to 20,000 cSt, a viscosity index equal to or greater than 230, and a degree of unsaturation equal to or less than 0.05 meq/g is provided. Further provided is a method for lubricating a mechanical device.

### FIELD OF INVENTION

The instant invention relates to a lubricant composition and a method to lubricate a mechanical device.

### BACKGROUND OF THE INVENTION

Sugarcane processing is based on a mechanical grinding process, where sugarcane is successively crushed by heavy three roll mills, in a sugarcane mill, in order to extract the sugarcane juice rich in sugar. The bearings and mandrels in the sugarcane mill (the crushing equipment) have a loss lubricant system sacrifice lubrication.

The lubricant is in contact with the sugarcane juice which will become the crystal sugar, through the mill's mandrels. The mills' crushing rolls are subject to heavy loads during sugarcane processing. Therefore, the lubricant needs to have very high viscosity, a very high viscosity index to provide good lubricity to the heavy capital intensive milling equipment, and also it needs to be water insoluble to avoid being washed away or diluted by the cane juice during grinding. Additionally, the driving gears for the heavy crushing rolls are requiring high viscosity and high performance lubricants. In open gears, water vapor condensation is generated in the open gears equipment. Therefore a water insoluble lubricant is also required to avoid dilution and incorporation of condensed water from vapor streams, so that proper lubrication can be provided at all times.

### SUMMARY OF THE INVENTION

The instant invention is a lubricant composition and a method to lubricate a mechanical device.

In one embodiment, the instant invention provides a lubricant composition comprising a polyoxypropylene polymer, the polyoxypropylene polymer having been prepared by polymerizing propylene oxide with an initiator containing a labile hydrogen in the presence of a double metal cyanide (DMC) catalyst, the polyoxypropylene polymer having a number average molecular weight ranging from 5,000 g/mol to 20,000 g/mol, a kinematic viscosity at 40° C. ranging from 1,200 to 20,000 cSt, a viscosity index greater than 230, and a degree of unsaturation lower than 0.05 meq/g.

### BRIEF DESCRIPTION OF THE DRAWINGS

FIG. 1 is a graph showing the 4-Balls Scar Wear Performance Inventive Example 1 (75 kg/60 min);

FIG. 2 is a graph showing the 4-Balls Scar Wear Performance of Inventive Example 1 and Comparative Example 1 (80 kg/30 min);

FIG. 3 is a graph showing the 4-Balls Scar Wear Performance of Inventive Example 1 at different loads and duration as indicated on the FIG. 3; and

FIG. 4 is a graph showing the viscosity of Inventive Example 1 and Comparative Examples 1-3.

### DETAILED DESCRIPTION OF THE INVENTION

The instant invention is a lubricant composition and a method to lubricate a mechanical device.

The lubricant composition according to the present invention comprises lubricant composition comprising a polyoxypropylene polymer, the polyoxypropylene polymer having been prepared by polymerizing propylene oxide with an initiator containing a labile hydrogen in the presence of a double metal cyanide (DMC) catalyst, the polyoxypropylene polymer having a number average molecular weight ranging from 5,000 g/mol to 20,000 g/mol, a kinematic viscosity at 40° C. ranging from 1,200 to 20,000 cSt, a viscosity index equal to or greater than 230, and a degree of unsaturation equal to or less than 0.05 meq/g.

In an alternative embodiment, the instant invention further provides a method for lubricating a mechanical device comprising using the lubricant composition according to any embodiment disclosed herein.

The polyoxypropylene polymer has a number average molecular, Mn, weight ranging from 5,000 to 20,000 g/mole. All individual values and subranges from 5,000 to 20,000 g/mole are included herein and disclosed herein; for example the Mn can be from a lower limit of 5,000; 10,000; 15,000; or 18,000 g/mole to an upper limit of 7,00; 13,000; 17,000; or 20,000 g/mole. For example, the Mn of the polyoxypropylene polymer can range from 5,000 to 20,000 g/mole, or in the alternative, the Mn of the polyoxypropylene polymer can range from 10,000 to 15,000 g/mole, or in the alternative, the Mn of the polyoxypropylene polymer can range from 12,000 to 20,000 g/mole, or in the alternative, the Mn of the polyoxypropylene polymer can range from 7,000 to 10,000 g/mole.

The polyoxypropylene polymer has a kinematic viscosity at 40° C. ranging from 1,200 to 20,000 cSt. All individual values and subranges from kinematic viscosity at 40° C. ranging from 1,200 to 20,000 cSt are included herein and disclosed herein; for example, the kinematic viscosity at 40° C. can be from a lower limit of 1,200; 5,000; 12,000; 15,000 or 18,000 cSt to an upper limit of 2,000; 7,500; 13,000; 16,000 or 20,000 cSt. For example, the kinematic viscosity at 40° C. can range from 1,200 to 20,000 cSt, or in the alternative, the kinematic viscosity at 40° C. can range from 12,200 to 20,000 cSt, or in the alternative, the kinematic viscosity at 40° C. can range from 1,200 to 12,000 cSt, or in the alternative, the kinematic viscosity at 40° C. can range from 8,000 to 18,000 cSt, or in the alternative, the kinematic viscosity at 40° C. can range from 1,200 to 2,000 cSt

The polyoxypropylene polymer has a viscosity index equal to or greater than 230. All individual values and subranges from equal to or greater than 230 are included herein and disclosed herein. For example, the viscosity index can be equal to or greater than 230, 240, 250, 260, 270, or 280.

The polyoxypropylene polymer has a degree of unsaturation equal to or less than 0.05 meq/g. All individual values and subranges from equal to or less than 0.05 meq/g are included herein and disclosed herein. For example, the unsaturation can be equal to or less than 0.05, 0.03, 0.01, 0.008, 0.006 or 0.004 meq/g.

Any double metal catalyst, DMC, or combination thereof can be used in embodiments of the invention. Such catalysts are well known in the art. Exemplary DMCs include zinc hexacyanocobaltate or quaternary phosphazenium compound. Catalysis with DMC catalysts is also known in the art such as in the disclosures of U.S. Pat. Nos. 3,404,109, 3,829,505, 3,941,849 and 5,158,922, 5,470,813, EP-A 700 949, EP-A 743 093, EP-A 761 708, WO-A 97/40086, WO-A 98/16310 and WO-A 00/47649, the disclosures of which are incorporated by reference herein.

Any suitable initiator having a labile hydrogen may be used in embodiments of the invention. In one embodiment, the initiator is a monol or a diol. Exemplary initiators include aliphatic polyhydric alcohols and monohydric alcohols. Exemplary aliphatic polyhydric alcohol initiators include those containing from two hydroxyl (OH) groups to six OH groups and from two carbon atoms (C2) to eight carbon atoms (C8) per molecule, as illustrated by compounds such as: ethylene glycol, propylene glycol, 2,3-butylene glycol, 1,3-butylene glycol, 1,4-butanediol, 1,3-propanediol, 1,5-pentane diol, 1,6-hexene diol, glycerol, trimethylolpropane, sorbitol, pentaerythritol, mixtures thereof and the like. Cyclic aliphatic polyhydric compounds such as starch, glucose, sucrose, and methyl glucoside may also be used. Exemplary monohydric alcohol initiators include the lower acyclic alcohols such as methanol, ethanol, propanol, butanol, pentanol, hexanol, neopentanol, isobutanol, decanol, and the like, as well as higher acyclic alcohols derived from both natural and petrochemical sources with from 11 carbon atoms to 22 carbon atoms. Furthermore, water can also be used as an initiator. An exemplary commercial initiator is DOWANOL™ PM, available from The Dow Chemical Company. Initiators with a labile hydrogen useful in embodiments of the invention include those which possess an —NH— group. Such initiators include, for example, alkanol amines, such as mono ethanol amine and diethanol amine; ethylene amines, such as ethylene diamine, diethylene triamine, triethylene tetraamine, and tetraethylene pentaamine; alkyl amines, such as dimethyl amine, diethyl amine, dipropyl amine, and dibutyl amine; and aryl amines, such as dibenzyl amine, ditoluene amine.

In an alternative embodiment, the instant invention provides a lubricant composition, and method of lubricating a mechanical device, in accordance with any of the embodiments disclosed herein, except that the lubricant composition further comprises an antioxidant. Any antioxidant, or combination thereof, useful in lubricant compositions may be used in embodiments of the invention. Exemplary antioxidants include phenol-based antioxidants and amine-based antioxidants. Examples of phenol-based antioxidants include 2,6-di-tert-butyl-4-methylphenyl; 2,6-di-tert-butyl-4-ethylphenol; 2,4,6-tri-tert-butylphenol; 2,6-di-tert-butyl-4-hydroxymethylphenyl; 2,6-di-tert-butylphenol; 2,4-dimethyl-6-tert-butylphenol; 2,6-di-tert-butyl-4-(N,N-dimethylaminomethyl)phenol; 2,6-di-tert-amyl-4-methylphenol; 4,4′-methylenebis(2,6-di-tert-butylphenol), 4,4′-bis(2,6-di-tert-butylphenol), 4,4′-bis(2-methyl-6-tert-butylphenol), 2,2′-methylenebis(4-ethyl-6-tert-butylphenol), 2,2′-methylenebis(4-methyl-6-tert-butylphenol), 4,4′-butylidenebis(3-methyl-6-tert-butylphenol), 4,4′-isopropylidenebis(2,6-di-tert-butylphenol), 2,2′-methylenebis(4-methyl-6-nonylphenol), 2,2′-isobutylidenebis(4,6-dimethylphenol), 2,2′-methylenebis(4-methyl-6-cyclohexylphenol), 2,4-dimethyl-6-tert-butylphenol, 4,4′-thiobis(2-methyl-6-tert-butylphenol), 4,4′-thiobis(3-methyl-6-tert-butylphenol), 2,2′-thiobis(4-methyl-6-tert-butylphenol), bis(3-methyl-4-hydroxy-5-tert-butylbenzyl)sulfide, bis(3,5-di-tert-butyl-4-hydroxybenzyl)sulfide, 2,2′-thio-diethylenebis[3-(3,5-di-tert-butyl-4-hydroxyphenyl).sub.p ropionate], tridecyl-3-(3,5-di-tert-butyl-4-hydroxyphenyl)propionate, pentaerythrityl-tetrakis[3-(3,5-di-tert-butyl-4-hydroxyphenyl) propionate], octyl-3-(3,5-di-tert-butyl-4-hydroxyphenyl)propionate, octadecyl-3-(3,5-di-tert-butyl-4-hydroxyphenyl)propionate, and octyl-3-(3-methyl-5-tert-butyl-4-hydroxyphenyl)propionate. Exemplary amine-based antioxidants include diphenylamine-based antioxidants, specifically, diphenylamine; alkylated dipehnylamines of alkyl groups having 3 to 20 carbon atoms such as a monooctyl diphenylamine; monononyldiphenylamine, 4,4′-dibutyl diphenylamine, 4,4′-dihexyl diphenylamine, 4,4′-dioctyl diphenylamine, 4,4′-dinonyl diphenylamine, tetrabutyl diphenylamine, tetrahexyl diphenylamine, tetraoctyl diphenylamine, and tetranonyl diphenylamine; napthylamine-based antioxidants, specifically, α-napthylamine and phenyl-α-napthylamine; and alkyl substituted phenyl-α-naphtyl amines having 3 to 20 carbon atoms such as butylphenyl-α-napthylamine, hexylphenyl-α-napthylamine, octylphenyl-α-napthylamine, and nonylphenyl-α-napthylamine. In a particular embodiment, the antioxidant is selected from the group consisting of butylated hydroxytoluene (BHT), octadecyl 3,5-Di-tert-butyl-4-hydroxyhydrocinnamate, and pentaerythritol tetrakis(3-(3,5-di-tert-butyl-4-hydroxyphenyl)propionate). Antioxidants commercially available under the name IRGANOX 1010 and IRGANOX 1076 from BASF may also be used in embodiments of the invention.

In an alternative embodiment, the instant invention provides a lubricant composition, and method of lubricating a mechanical device, in accordance with any of the embodiments disclosed herein, except that the polyoxypropylene polymer has a water solubility of equal to or less than 0.5 wt % water at 25° C. and atmospheric pressure. All individual values and subranges from equal to or less than 0.5 wt % water are included herein and disclosed herein. For example, the water solubility of the polyoxypropylene polymer can be equal to or less than 0.5, 0.4, or 0.3 wt % water at 25° C. and atmospheric pressure.

In another embodiment, the lubricant composition in accordance with any of the embodiments described herein, is used as a lubricant in mechanical equipment in need of a low water solubility, high viscosity lubricant. “Low water solubility” as used herein means having equal to or less than 0.5 wt % water solubility at 25° C. and atmospheric pressure. “High viscosity” as used herein means having a kinematic viscosity at 40° C. of equal to or greater than 1,200 cSt.

In an alternative embodiment, the instant invention provides a lubricant composition, and method of lubricating a mechanical device, in accordance with any of the embodiments disclosed herein, except that the polyoxypropylene polymer has up to 10% ethylene oxide random copolymerization. All individual values and subranges from up to 10% ethylene oxide random copolymerization are included herein and disclosed herein. For example the amount of ethylene oxide random copolymerization can be from an upper limit of 10, 8, 6 or 4%.

In an alternative embodiment, the instant invention provides a lubricant composition, and method of lubricating a mechanical device, in accordance with any of the embodiments disclosed herein, except that the lubricant composition is a lubricant for use in a sugarcane mill's open gears, gearboxes (sealed or unsealed), tandem bearings, and/or journal bearings.

### EXAMPLES

The following examples illustrate the present invention but are not intended to limit the scope of the invention.

Inventive Example 1 was DMC catalyzed polypropylene glycol having a number average molecular weight of about 8000 g/mole, a kinematic viscosity at 40° C. of 1618 cSt, a kinematic viscosity at 100° C. of 239 cSt, a viscosity index of 280, and a degree of unsaturation equal to or less than 0.05 meq/g. Inventive Example 1 was prepared using propylene glycol initiator and Irganox 1076 antioxidant.

Comparative Example A was polyisobutylene (PIB) having a viscosity index of 212, a viscosity of 1601 cSt at 40° C., and a viscosity of 155 cSt at 100° C.

Comparative Example B was a polyalphaolefin (PAO) having a viscosity index of 170, a viscosity of 1250 cSt at 40° C., and a viscosity of 100 cSt at 100° C.

Comparative Example C was polyisobutylene (PIB) having a viscosity index of 130, a viscosity of 1600 cSt at 40° C., and a viscosity of 90 cSt at 100° C.

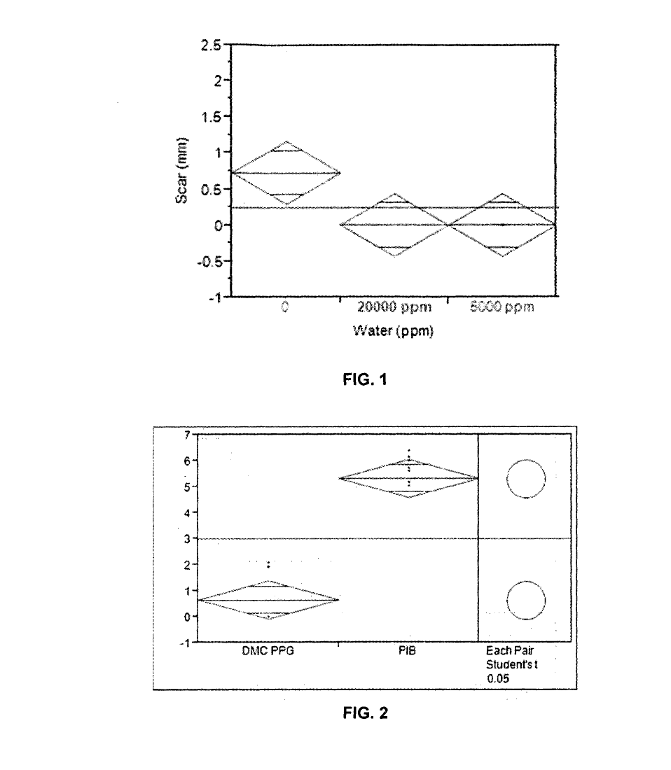

FIG. 1 shows the 4-balls scar wear performance (under 75 kg load for 60 minutes) results for Inventive Example 1 with 0 ppm water, 20000 ppm water and 5000 ppm water. As can be seen in FIG. 1, the performance of Inventive Example 1 does not degrade in the presence of up to 20000 ppm water.

FIG. 2 shows the 4-balls scar wear performance (under 80 kg load for 30 minutes) results for Inventive Example 1 and another PIB with a viscosity of 240 cSt at 100° C. and a viscosity index of 130. As can be seen in FIG. 2, Inventive Example 1 shows superior performance this NB.

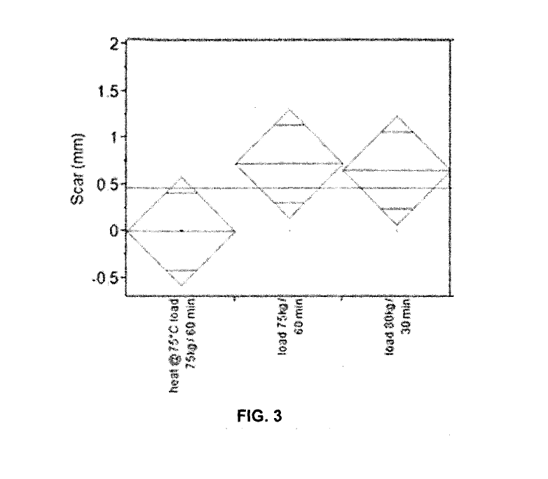

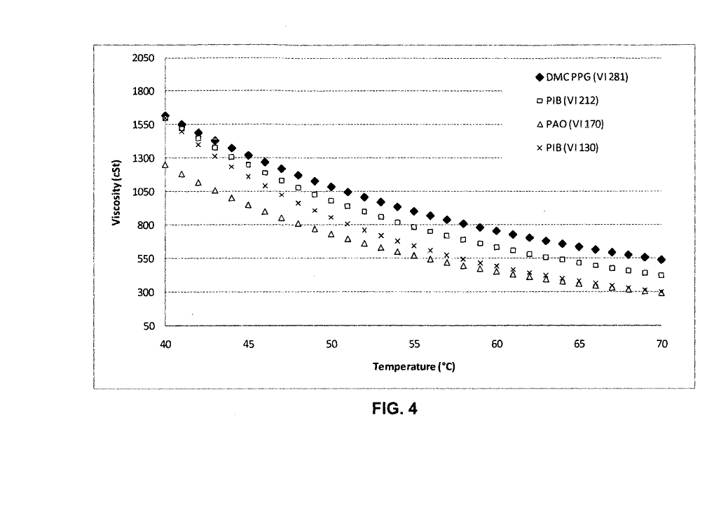

FIG. 3 shows the 4-balls scar wear performance (under 80 kg load for 30 minutes) results for Inventive Example 1 under three different conditions: (a) 75° C., 75 kg load for 60 minutes; (b) 25° C., 75 kg load for 60 minutes; and (c) 25° C., 80 kg load for 30 minutes. As can be seen in FIG. 3, Inventive Example 1 provides good performance at all three conditions.

### Test Methods

Test methods include the following:

4-Balls Scar Wear Performance is determined by ASTM D-2596 modified as indicated for each set of results illustrated in FIGS. 1-3.

Viscosity was measured according to ASTM D 445/446.

Viscosity index was determined according to ASTM D2270.

The present invention may be embodied in other forms without departing from the spirit and the essential attributes thereof, and, accordingly, reference should be made to the appended claims, rather than to the foregoing specification, as indicating the scope of the invention.

1. A lubricant composition comprising a polyoxypropylene polymer, the polyoxypropylene polymer having been prepared by polymerizing propylene oxide with an initiator containing a labile hydrogen in the presence of a double metal cyanide (DMC) catalyst, the polyoxypropylene polymer having a number average molecular weight ranging from 5,000 g/mol to 20,000 g/mol, a kinematic viscosity at 40° C. ranging from 1,200 to 20,000 cSt, a viscosity index equal to or greater than 230, and a degree of unsaturation equal to or less than 0.05 meq/g.

2. The lubricant composition of claim 1 further comprising an antioxidant.

3. The lubricant composition of claim 1 wherein the polyoxypropylene polymer has a number average molecular weight ranging from 7,000 g/mol to 10,000 g/mol.

4. The lubricant composition of claim 1 wherein the polyoxypropylene polymer has a viscosity index equal to or greater than 250.

5. The lubricant composition of claim 1 wherein the polyoxypropylene polymer has a kinematic viscosity at 40° C. ranging from 1,200 to 2,000 cSt.

6. The lubricant composition of claim 1 wherein the initiator containing a labile hydrogen is a monol or a diol.

7. The lubricant composition of claim 1 wherein the polyoxypropylene polymer has a water solubility of equal to or less than 0.5 wt % water at 25° C. and atmospheric pressure.

8. The lubricant composition of claim 1 for use as a lubricant in mechanical equipment in need of a low water solubility, high viscosity lubricant.

9. The lubricant composition of claim 1 for use as a lubricant in a sugarcane mill's open gears, gearboxes, tandem bearings, and/or journal bearings.

10. A method of lubricating a mechanical device requiring a water insoluble high viscosity lubricant, the method comprising using the lubricant composition of claim 1 to lubricate the mechanical device

11. The method of claim 10 wherein the mechanical device is a sugarcane mill's open gears, gearboxes, tandem bearings, and/or journal bearings.
